(19) United States
(12) Patent Application Publication
(10) Pub. No.: US 2015/0106122 A1
(43) Pub. Date: Apr. 16, 2015

(54) METHOD, SERVER AND RECORDING MEDIUM FOR PROVIDING ELECTRONIC PATIENT INFORMATION

(71) Applicant: GENERAL ELECTRIC COMPANY, Schenectady, NY (US)

(72) Inventors: KyooHo Lee, Incheon (KR); Jahyoung Park, Incheon (KR); Marcelo Duarte Esperidiao, Incheon (KR)

(73) Assignee: GENERAL ELECTRIC COMPANY, Schenectady, NY (US)

(21) Appl. No.: 14/512,760

(22) Filed: Oct. 13, 2014

(30) Foreign Application Priority Data
Oct. 15, 2013 (KR) 10-2013-0122680

(51) Int. Cl. G06F 19/00

(52) U.S. Cl. CPC G06F 19/322
USPC 705/3

(57) ABSTRACT

A method of providing an event tree enabling institutive understanding of the creation of electronic patient information including or any changes in electronic patient information, a server for performing the same, and a recording medium for storing the same are provided. A method for providing electronic patient information includes receiving electronic patient information of a patient from at least one terminal, identifying one or more events from the received electronic patient information, and generating an event tree of the patient based on the identified events, wherein the event tree graphically represents the electronic patient information of the patient.

### CROSS REFERENCE TO RELATED APPLICATIONS

This application claims the benefit of Korean Patent Application No. 10-2013-0122680, filed on Oct. 15, 2013, with the Korean Intellectual Property Office, the disclosure of which is incorporated herein in its entirety by reference.

### BACKGROUND

The present invention relates to a method of providing electronic patient information, a server for performing the same, and a computer-readable storage medium storing a computer program that, when executed by a computer, causes the computer to execute the method of providing electronic patient information. More particularly, the present invention relates to a method for enabling intuitive understanding of the history or the changes of the patient information and a server for performing the same.

Recently, as the number and size of hospitals rapidly increase, the hospitals provide identification numbers to patients for managing patients' information. Meanwhile, a patient often visits several hospitals for a symptom, seeking for diagnostic opinions from different doctors. In such case, the patient will have many different identification numbers.

In such case, managing of the personal information of the patient by the several hospitals may be performed, e.g., by mapping the patient identification number to the hospital information. Further, the personal information inputted by the several hospitals may be merged together, providing current and holistic patient information such that one hospital can use the current and holistic information for treating the patient.

In this regard, there has been introduced an enterprise master patient index system. Enterprise Master Patient Index (EMPI) systems keep patients belonging to multiple medical domains on a centralized index. The EMPI system can also merge patients, receive merge requests from the domains, and receive updated demographic information from the domains.

A conventional EMPI system, e.g., designed by KTC, has a simple approach, which requires manual reconstruction of the patient information. Such an EMPI system stores all events that change demographics and displays current demographics only. With this information, the user can manually reconstruct the changes of demographics over time by looking at the data one by one.

For example, Korean Patent Publication No. 10-2010-0097524 (published on Sep. 3, 2010) discloses a method of transmitting patient information built by medical institution A to medical institution B upon receiving request from medical institution B, such that the medical institution B can use such patient information in treating the patient.

Other examples of the conventional EMPI system have been disclosed in the following documents:

U.S. Patent Publication No. 2011/0125527A1, published on May 26, 2011, entitled “SYSTEMS, APPARATUS, AND METHODS FOR IDENTIFYING PATIENT-TO PATIENT RELATIONSHIPS,” discloses a method for identifying patient-to-patient relationships among patient electronic medical data. This method includes examining electronic patient information for identifiers related to a first patient, matching the one or more identifiers related to the first patient with identifiers from electronic patient information related to a second patient and providing electronic access to linked electronic patient information for the second patient when reviewing the electronic patient information for the first patient;

U.S. Patent Publication No. 2011/0125528A1, published on May 26, 2011, entitled “SYSTEMS, APPARATUS, AND METHODS FOR DEVELOPING PATIENT MEDICAL HISTORY USING HIERARCHICAL RELATIONSHIPS,” discloses an apparatus for providing access to electronic health information for patient, which involves patient indicators and graphical relationship indicators that are displayed on display through user interface;

U.S. Pat. No. 7,725,331B1, published on May 25, 2010, entitled “SYSTEM AND METHOD FOR IMPLEMENTING A GLOBAL MASTER PATIENT INDEX,” discloses a global master patient index maintaining method for use in, e.g., large hospital, which involves creating unconfirmed link between patient record and each matching record, if matching records for patient record are found in database;

U.S. Patent Publication No. 2013/0080192A1, published on Mar. 28, 2013, entitled “IDENTITY MATCHING OF PATIENT RECORDS,” discloses a system for matching pair of patient records in medical workstation, which has match detector for detecting whether patient records relate to same patient based on clinical properties and matching rules; and

WO2011/042838A1, published on Apr. 14, 2011, entitled “AUTONOMOUS LINKAGE OF PATIENT INFORMATION RECORDS STORED AT DIFFERENT ENTITIES,” discloses a system for linking patient information records stored at different entities, which has link established when given patient information matches corresponding information based on identification algorithm.

However, with the above-mentioned examples, it was difficult or impossible to show the history or the changes of the patient information. That is, it was difficult or impossible to visualize the changes of the demographics of patient(s). Therefore, for example, any input error occurred during the build-up of the information may cause an error in the current information, and the error in the current information may cause a fatal malpractice when treating an unconscious patient. Further, since there is no way to review the history or the changes of the patient information, the patient or the family can never know which hospital made the input error.

### BRIEF DESCRIPTION

The disclosure provides a method of providing an event tree showing the history or changes of electronic patient information through visualization, a server for performing the same, and a computer-readable storage medium storing a computer program that, when executed by a computer, causes the computer to execute the above method. However, the technical subject of the disclosure is not limited to the foregoing technical subjects, and there may be other technical subjects.

In one exemplary embodiment, a method for providing electronic patient information is provided. The method includes receiving electronic patient information of a patient from at least one terminal, identifying one or more events from the received electronic patient information, and generating an event tree of the patient based on the identified events, wherein the event tree graphically represents the electronic patient information of the patient.

According to one aspect of the exemplary embodiment, when the personal information of a patient has been updated, all of the updates and the terminals (i.e., hospitals) which recorded the updates can be visualized. Therefore, it is possible to understand when and by whom the updates have been made as well as the history or changes of the patient information including patient demographics information (such as name, age, sex, address, social security number, etc.), clinical information (such as electronic medical records, electronic health records, personal health records, etc.), etc.

### BRIEF DESCRIPTION OF THE DRAWINGS

The features of the systems and methods described herein will become apparent from the following description of exemplary embodiments given in conjunction with the accompanying drawings, in which:

FIG. 1 shows a schematic view of a system for providing electronic patient information in accordance with an exemplary embodiment;

FIG. 2 illustrates a block diagram of a server for providing electronic patient information as illustrated in FIG. 1;

FIGS. 3A to 3H are views illustrating an event tree generated by the electronic patient information server of FIG. 1 and the concept of the event included in the event tree; and

FIG. 4 is a flow-chart illustrating the method of providing electronic patient information in accordance with an exemplary embodiment.

### DETAILED DESCRIPTION

Hereinafter, exemplary embodiments will be described in detail with reference to the accompanying drawings so that those skilled in the art can readily implement them. However, the systems and methods described herein may be implemented in different forms, but it is not limited thereto. In the drawings, further, portions unrelated to the description of the systems and methods described herein will be omitted for clarity of the description, and like reference numerals and like components refer to like elements throughout the detailed description.

In the entire specification, when a portion is “connected” to another portion, it means that the portions are not only “connected directly” with each other, but also they are “electrically or wirelessly connected” with each other by way of another device or medium therebetween. Further, when a portion “comprises” a component, it means that the portion does not exclude another component but may further comprise other components unless otherwise described.

The term “patient information” may include any information used for identifying and treating the patient, such as patient demographics information (such as name, age, sex, address, phone number, etc.), insurance information, clinical information (such as electronic medical records, electronic health records, personal health records, etc.), etc.

Hereinafter, exemplary embodiments will be described with reference to the accompanying drawings.

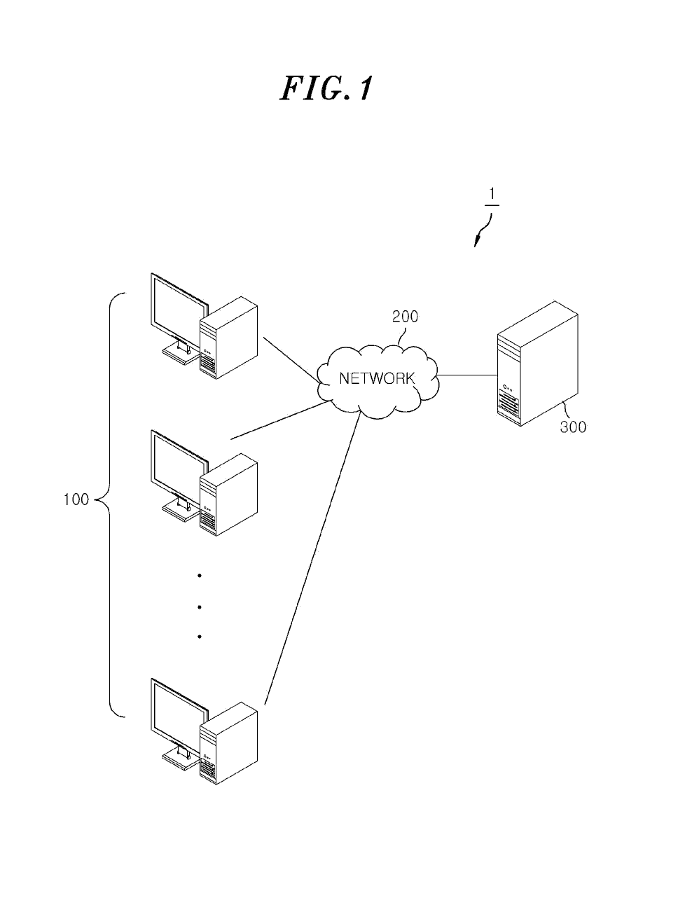

FIG. 1 shows a schematic view of a system for providing electronic patient information in accordance with an exemplary embodiment. Referring to FIG. 1, a system 1 for providing electronic patient information may include at least one terminal 100 and one electronic patient information server 300. However, it should be understood that the system 1 for providing electronic patient information of FIG. 1 is merely an example and the disclosure is not construed to be limited to the example shown in FIG. 1.

The components as illustrated in FIG. 1 may be generally connected to each other via a network 200. For example, as illustrated in FIG. 1, the terminal 100 may be connected to the electronic patient information server 300 via the network 200. Here, the network 200 used herein refers to a connection for exchanging information between the terminal(s) and the server. The network 200 may include, e.g., the Internet, LAN (Local Area Network), Wireless LAN (Local Area Network), WAN (Wide Area Network), PAN (Personal Area Network), 3G network, 4G network, LTE network, Wi-Fi network, or the like, but is not limited thereto. Further, it is understood that the terminal 100 and the electronic patient information server 300 are also not limited to those illustrated in FIG. 1.

The terminal 100 may be a terminal which personal information of a patient is inputted to and stored therein. For example, the terminal 100 may generate electronic patient information by storing and updating the personal information of a patient. Moreover, the terminal 100 may assign an identification (ID) to each patient, map the ID to the personal information of the patient, and store them. Also, the terminal 100 may generate a demographics sheet based on the electronic patient information.

The demographics sheet includes current demographics information for a patient. The demographics sheet is composed of fields, each containing different demographics information.

The terminal 100 may transmit the generated electronic patient information to the electronic patient information server 300 and may receive an event tree that is made from the electronic patient information by the electronic patient information server 300. Here, the terminal 100 may be able to access a remote server and/or other remote terminal over the network 200. The terminal 100 may include a hand-held wireless communication device that ensures portability and mobility, including, e.g., a smart phone, a smart pad, a Tablet PC, used in PCS (Personal Communication System), GSM (Global System for Mobile communications), PDC (Personal Digital Cellular), PHS (Personal Handy phone System), PDA (Personal Digital Assistant), IMT (International Mobile Telecommunication)-2000, W-CDMA (W-Code Division Multiple Access), Wibro (Wireless Broadband Internet).

The electronic patient information server 300 may receive the electronic patient information of a patient from the terminal 100, identify one or more events, which may have been happened to a patient, from the electronic patient information, and generate an event tree for the patient based on the identified events and the received electronic patient information.

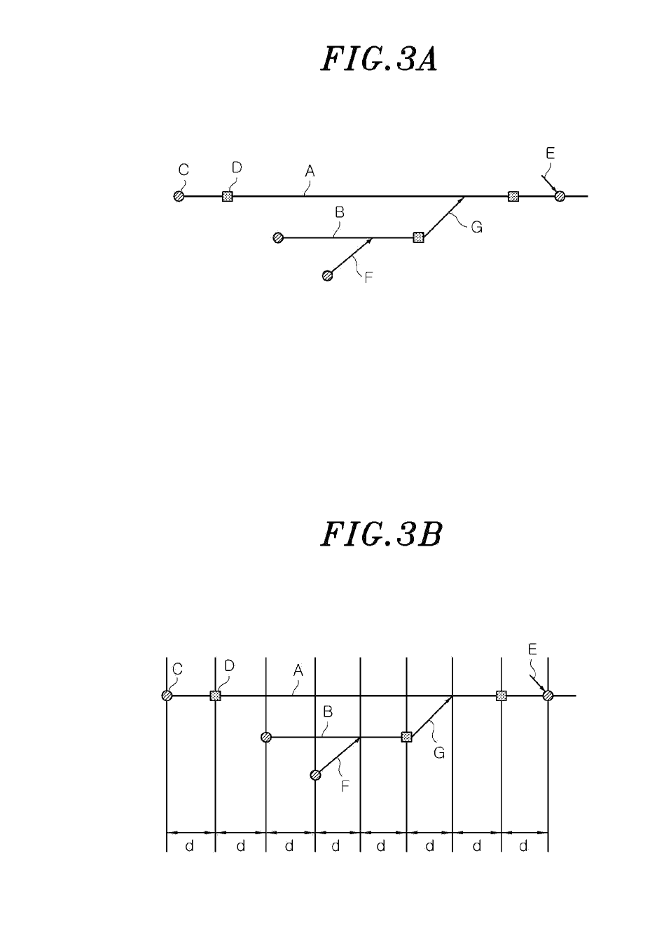

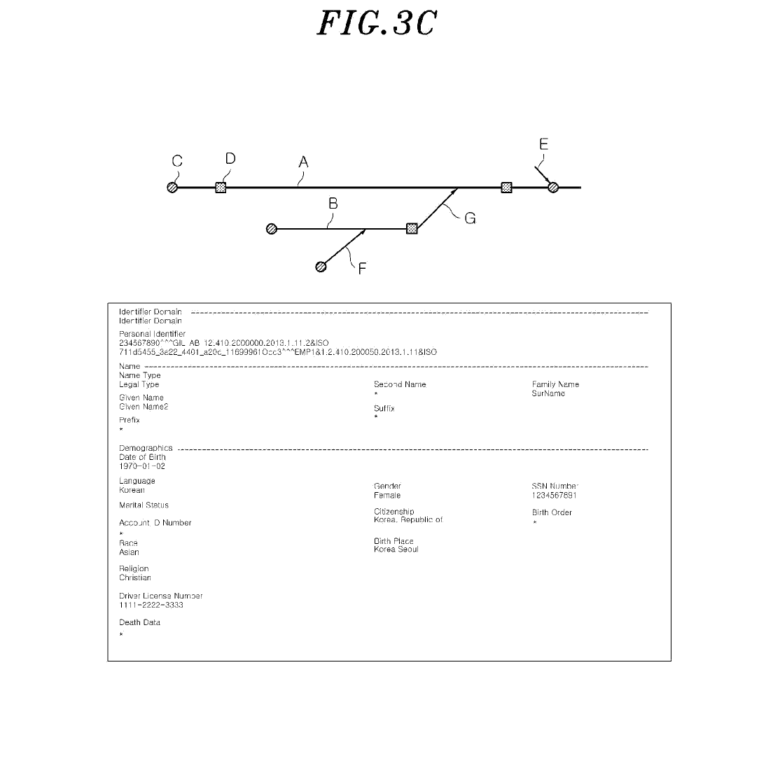

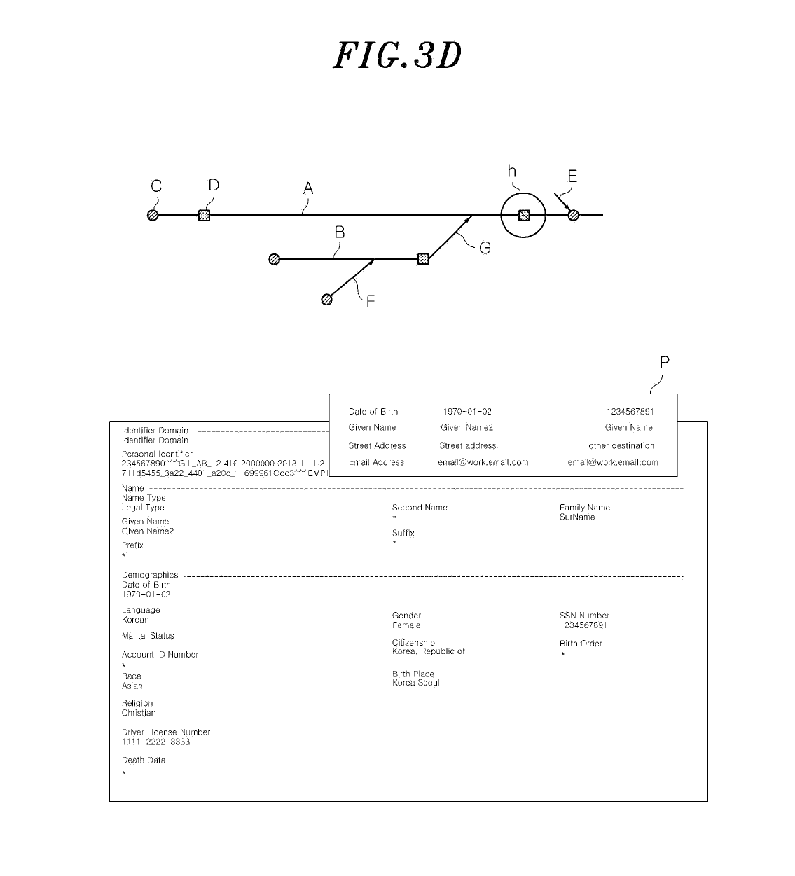

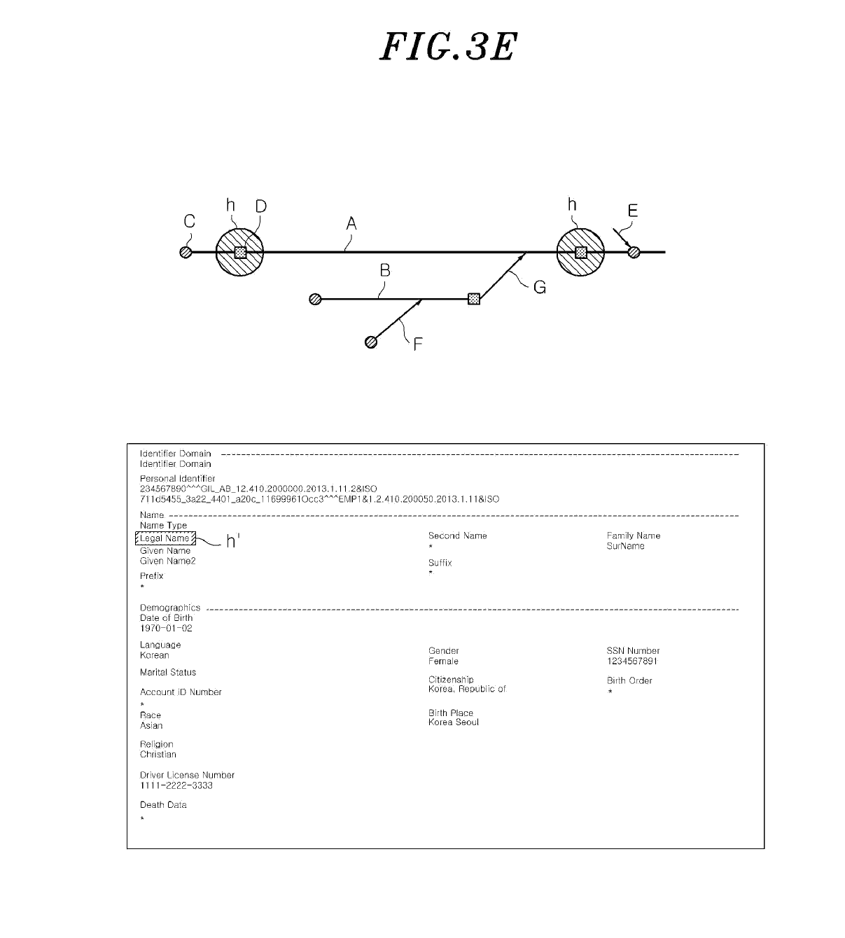

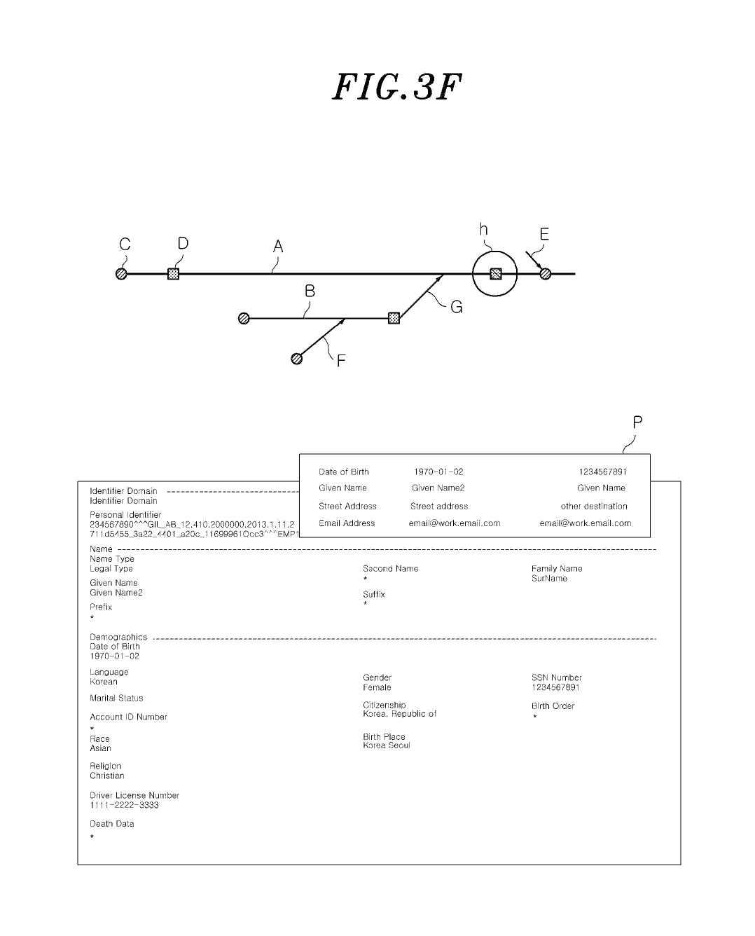

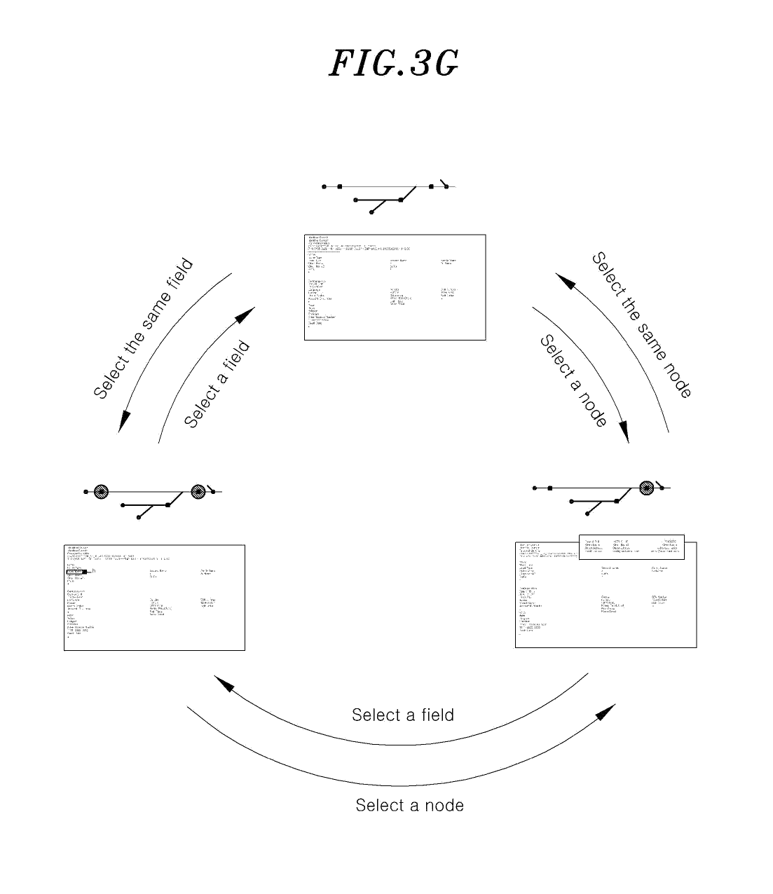

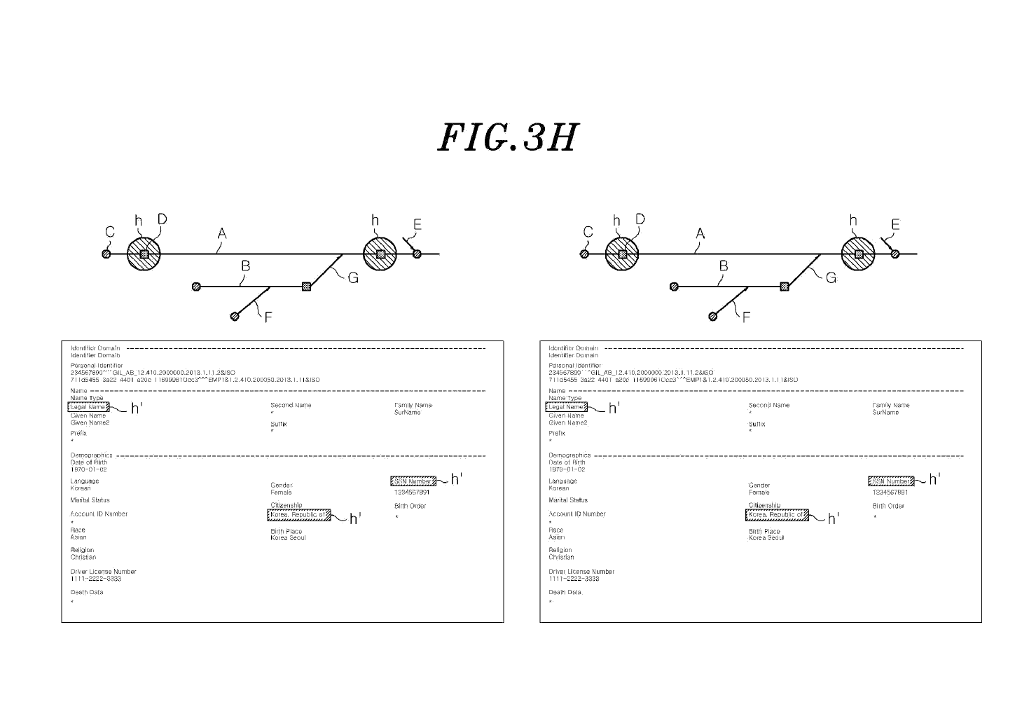

Here, the event tree may refer to a tool for visually providing the graphical representation of the electronic patient information of a patient. Specifically, as shown in FIG. 3, the event tree may be a tree-like visual tool having nodes that symbolize events that may happen to a patient. Each node represents an event identified from the electronic patient information of a patient, placed in chronological order of the occurrence of the events. In other words, based on the events identified from the electronic patient information of a patient, the event tree may show the electronic patient information in chronological order. Further, the event tree may have one or more horizontal parallel lines, which symbolize respective patients, each line having at least one node thereon.

When the electronic patient information server 300 receives a request for a patient (or an electronic patient information or an event tree) from the terminal 100, the electronic patient information server 300 may generate an event tree of the patient and transmit the generated event tree to the terminal 100 such that the event tree can be displayed on the terminal 100. While searching for the information of the patient, it can be found that there exists another patient who appears to be identical to the requested patient (e.g., when several information for the patient were created by different hospitals). In such case, the electronic patient information server 300 may calculate matching ratio between the electronic patient information of the two patients and may merge the event trees of the two patients when the matching ratio exceeds a preset threshold value. If the matching ratio does not exceed the preset threshold value, the electronic patient information server 300 may transmit the patient information and the event trees of the two patient to the terminal such that a user of the terminal 100 can determine whether the two patients are actually the same patient and thus to merge the two event trees.

The electronic patient information server 300 may be implemented by a terminal that can access a remote server or other remote terminals over the network 200. The electronic patient information server 300 may include a computer system that may have access to a server or a terminal through the network 200. Here, the computer system may include a notebook computer, a desktop computer, and a laptop computer, in which a Web browser is mounted, for example. The electronic patient information server 300 may also include a terminal of PCS (Personal Communication System), GSM (Global System for Mobile communications), PDC (Personal Digital Cellular), PHS (Personal Handy phone System), PDA (Personal Digital Assistant), IMT (International Mobile Telecommunication)-2000, W-CDMA (W-Code Division Multiple Access), and Wibro (Wireless Broadband Internet), a smartphone, a smart pad, a Tablet PC, or the like.

When the electronic patient information server 300 or another server (not shown) in cooperation with the electronic patient information server 300 transmits a program for providing electronic patient information to the at least one terminal 100, the terminal 100 may install or open an application, a program, a web-page for receiving corresponding services, or the like of a relevant service. Moreover, the program for providing electronic patient information may be executed by a script performed in a web browser in the terminal 100.

Further, the application means a program on a terminal and includes, for example, an App that is executed in a mobile terminal (e.g., a smartphone). The App may be downloaded from a mobile application market that is a virtual marketplace where various mobile contents are bought and sold.

According to an exemplary embodiment, the method of providing electronic patient information may provide an event tree enabling intuitive understanding of the creation of the electronic data of patient information including an identification of a patient or any changes in the electronic patient information. Moreover, in accordance with another exemplary embodiment, an infrastructure may be constructed in which all of the changes of the patient information and a specific terminal (i.e., a hospital) where the personal information has been changed may be displayed such that the history or the changes of the electronic patient information can be easily understood.

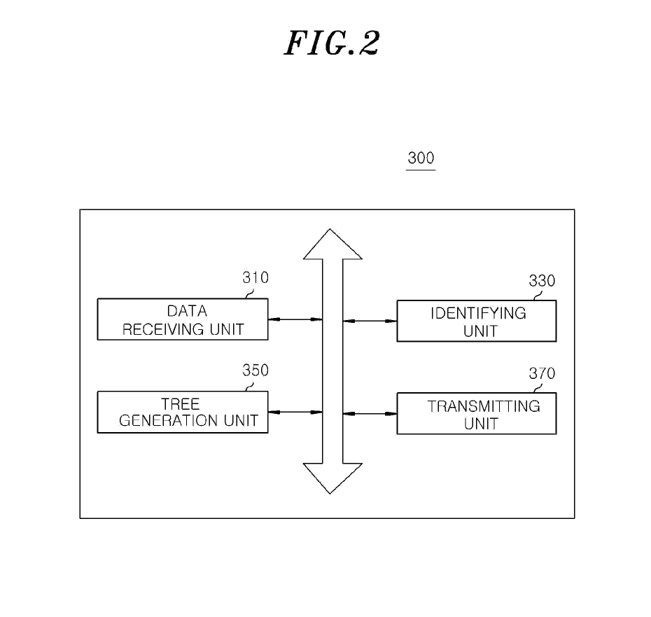

FIG. 2 illustrates an exemplary block diagram of the server for providing electronic patient information, as illustrated in FIG. 1, and FIGS. 3A to 3H are views illustrating an event tree generated by the electronic patient information server 300 of FIG. 1.

Referring to FIG. 2, the electronic patient information server 300 may include a data receiving unit 310, an identifying unit 330, a tree generation unit 350, and a transmitting unit 370.

The data receiving unit 310 receives electronic patient information of a patient from the terminal 100. The demographics information contained in the demographics sheet may include a telephone number, gender, age, address, race, a driver's license number, and at least one identifier provided by the terminal 100. For example, when woman A, who has a telephone number D, changes her last name from her maiden name B to her husband's name C after she got married, the electronic patient information (or demographics information) of the woman A is B, C and D.

The electronic patient information may be either already stored in the electronic patient information server 300, or newly transmitted to the electronic patient information server 300 from the terminal 100.

The demographics sheet may include demographics information organized in fields (or keys). A field may be used for, e.g., a name, gender, race, telephone number, or the like and the value thereof may be, e.g., a woman, Jane Doe or 010-1234-5678.

The identifying unit 330 identifies one or more events from the electronic patient information. Here, the one or more events may include a generation event indicating the generation of a new ID for the electronic patient information of a patient, and an update event indicating the change of a value of the electronic patient information of a patient. For example, the generation event may refer to an event in which the terminal 100 assigns a new ID to a patient for his/her identification. The update event may refer to an event in which the terminal 100 updates the electronic patient information when the personal information is modified. In this embodiment, the generation event may be represented by a generation symbol and the update event may be represented by an update symbol, wherein the generation symbol may have a shape of circle and the update symbol may have a shape of rectangle.

The identifying unit 330 may also assign a global identifier (ID) to a patient and may map the global ID to an ID already provided to the patient by the terminal 100. For example, when an ID of F has already been assigned to a patient A by a hospital E, the identifying unit 330 may assign a global ID of G to the patient A and map the global ID of G with the ID of F.

The tree generation unit 350 may generate the event tree for a patient based on the identified events. As described before, the event tree may refer to a tree-like visual tool for graphically representing the electronic patient information of a patient, having one or more parallel lines each having at least one node. Referring now to FIG. 3A, an example of the event tree is shown, which is composed of one or more horizontal parallel lines, each symbolizing a patient.

The tree generation unit 350 may compare the electronic patient information of a patient represented by one event tree with the electronic patient information of a patient represented by another event tree, and calculate the matching ratio therebetween. Here, said one event tree and said another event tree may respectively represent the electronic patient information of different patients, or may represent that of the same patient.

If the calculated matching ratio is greater than or equal to a first preset threshold value (e.g., 90%), the tree generation unit 350 may merge said one event tree into said another event tree. In this case, the first threshold value may be preset to 90 percentage (%).

When the calculated matching ratio is less than the first threshold value but greater than or equal to a third threshold value (e.g., 80%), the tree generation unit 350, without merging the two event trees, may transmit said one event tree and said another event tree to the terminal 100 so that a user of the terminal may determine whether to merge the two event trees. In this case, the third threshold value may also be preset to a value less than the first threshold value. For example, the third threshold value may be 80% and the first preset threshold value may be 90%.

In case where the calculated matching ratio is greater than or equal to the first threshold value and less than a second threshold value, said one event tree and said another event tree may be merged at a node having a first symbol (or patient merger-deterministic symbol). The first symbol may indicate that said one event tree and said another event tree are partially matched. That is, the first symbol may indicate that the electronic patient information of a patient represented by said one event tree and that of said another event tree are matched in part. The second threshold value may be preset to a value greater than the first threshold value. The second threshold value may be equal to 100%.

The 100 percentages matching ratio, which may be the second threshold value, may refer to the case where the values of a unique key (or a unique field) of the electronic patient information of a patient and that of another patient are identical. For example, a patient with an ID A may have a telephone number 12345678 and a resident registration number (a social security number or ID card number) of 810115-1234567 and another patient with an ID B may have a telephone number 87654321, a resident registration number 810115-1234567. If the resident registration number is set to be a unique key, since the resident registration numbers of the patient A and the patient B are identical even though their telephone numbers are different, the tree generation unit 350 may determine that the matching ratio of the electronic patient information of patients A and B is 100%.

Meanwhile, when the calculated matching ratio is greater than or equal to the second threshold value, said one event tree and said another event tree may be merged at a node having a second symbol (or patient merger-identical symbol). In this case, the second threshold value may be greater than the first threshold value. In the merging step, the event tree into which another event tree is merged (hereinafter referred to as a “dominant event tree”) may be graphically activated and the event tree merged into the dominant event tree (hereinafter, a “merged event tree”) may be graphically deactivated.

In an event tree, distances between each pair of two neighboring nodes may be identical. For example, a terminal 100 might have generated electronic patient information of patient A in 1981, while his or her telephone number changed in 2011 and his or her address changed in 2013. In this case, the nodes respectively representing the generation event, the update event of the telephone number change and the update event of the address change are not arranged at distances proportional to the time lengths between the events, but the distances between the neighboring nodes may be identical regardless of the time lengths between the events.

The transmitting unit 370, upon receiving a request for a patient information (or event tree of the patient) from the at least one terminal 100, may transmit the generated event tree to the terminal 100 so that the terminal 100 can display the generated event tree. For example, hospital A (or a terminal in hospital A) has generated the electronic patient information of the patient Z, hospital B has updated the electronic patient information of the patient Z, and then hospital C has generated new electronic patient information of the patient Z. In this case, hospital C may access the electronic patient information server 300 to look-up the patient information of the patient Z, which has been created by hospital A and/or updated by hospital B. Then, if necessary, the electronic patient information server 300 may transmit the event tree of the patient Z (e.g., merged event tree if it is decided that all of the three pieces of information represent patient Z) to the terminal in the hospital C.

In addition, the transmitting unit 370 may transmit the electronic patient information of a patient together with the generated event tree upon receiving a request for event tree and patient information from the at least one terminal 100. Further, the transmitting unit 370, upon receiving the request for patient information from the at least one terminal 100, may transmit to the terminal 100 only the electronic patient information of the patient. For example, hospital A (or a terminal in hospital A) might have generated the electronic patient information of patient Z, and modified the telephone number afterwards. In such case, when hospital B request patient information of patient Z, only the event tree (without merging) and the electronic patient information of patient Z generated and modified by hospital A may be transmitted to hospital B.

Hereinafter, the method of providing the electronic patient information in accordance with an exemplary embodiment will be described in more detail.

FIG. 3A is an example of an event tree graphically representing electronic patient information of a patient in accordance with an exemplary embodiment. Referring to FIG. 3A, as set forth above, the event tree has multiple parallel lines. Some lines have their right ends bending. Each parallel line, which symbolizes a patient, has nodes on them. The left end of a line symbolizes the admission time of the patient into the system for providing electronic patient information in accordance with the exemplary embodiment. Further, the line may symbolize one of two types of a patient: a dominant patient and a merged patient. In FIG. 3A, line ‘A’ indicates the dominant event tree and line ‘B’ indicates the merged event tree that is (to be) merged into line A.

For dominant patient line, the right end of a line does not bend. An event tree has only one dominant patient, i.e., only one line with its right end not bending. The right end of the line of the dominant patient symbolizes the most up-to-date event. The line of the dominant patient, when displayed, may look more emphasized than other lines.

For merged patient line, the right end of the line bends and ends on another line. The line of the merged patient bending and ending on another line symbolizes the merged patient being merged to another patient (based on the determination that the two patients are actually the same person). After the merger, lines of merged patients become dim or disabled.

Further, in FIG. 3A, the node may symbolize one of two types of information: an identifier assigned to a patient and patient demographics information created and updated/changed.

If projected on the dominant patient line, all nodes may be displayed in the order the events happened, no node overlap, and the distance between each node may be always the same.

In FIG. 3A, Node ‘C’ is a local ID creation representing an event of generation of electronic patient information of a patient, where the electronic patient information includes, e.g., an identifier of the patient and demographics information. Meanwhile, node ‘D’ is an update node representing an event of update of the electronic patient information.

An arrow ‘E’ is a patient merge-identical symbol representing identicalness of two patients when the matching ratio between the two respective pieces of the patient information of the two patients is greater than or equal to the second threshold value (e.g., 100%). As shown, the patient merge-identical symbol may have a shape of arrow heading toward the dominant line A.

An arrow ‘F’ is a patient merge-deterministic symbol representing that the electronic patient information of two patients are matched in part with a matching ratio greater than or equal to the first threshold value (e.g., 90%) and less than the second threshold values (e.g., 100%). In this case, the patient merge-deterministic symbol may have a shape of arrow heading out of the ID creation symbol.

An arrow ‘G’ is a patient merge-probabilistic symbol representing that the electronic patient information of two patients are matched in part with a matching ratio greater than or equal to the third threshold value (e.g., 80%) and less than the first threshold values (e.g., 90%), and thus merged by a user of the terminal. As shown, the patient merge-probabilistic symbol may have a shape of arrow bent toward the dominant line A.

The dominant event tree A may be graphically activated by being visually emphasized with a thick line or other visual effects. Meanwhile, the merged event tree B may be graphically deactivated by being displayed as a thin line or displayed in gray scale.

FIG. 3B shows a graph in which an event tree is projected to X-Y axis. Referring to FIG. 3B, at least one event is represented by at least one symbol such as a rectangle or a circle. Specifically, a generation event may be represented by the ID creation symbol and an update event may be represented by the update symbol. Here, the ID creation symbol may be a circle and the update symbol may be a rectangle.

In FIG. 3B, the distance ‘d’ between a pair of two symbols that are adjacent to each other on the same line are the same: each node is spaced apart from its neighboring node(s) on the same line at the same predetermined distance (here ‘d’). Thus, the event trees according to an exemplary embodiment may have all events indicated by circles and rectangles as uniformly distanced apart, with the predetermined interval between two adjacent events.

FIG. 3C illustrates a demographics view having an event tree of a patient along with a corresponding demographics sheet containing the most current demographic information of the patient, in accordance with an exemplary embodiment. The demographics view allows the user to understand the history of changes of the demographics information.

Referring to FIG. 3C, the electronic patient information server 300 of an exemplary embodiment, upon receiving of a request for patient information (or event tree of the patient) from the terminal 100, may transmit the generated event tree of the patient so that the generated event tree is displayed by the terminal 100. In this step, together with the event tree, the terminal 100 may also display the demographics sheet. In particular, the terminal 100 may display at least one key (or field) representing the personal information of the patient and at least one value mapped to the at least one key. The at least one key may be, e.g., ‘gender’ and/or ‘citizenship’ and the at least one value mapped to the at least one key may be, for example, ‘female’ and/or ‘Korea.’

FIG. 3D illustrates the demographics view having a comparison table over the demographics sheet. The comparison table allows a user to compare prior patient information and post patient information (i.e., patient information before and after an update event), with respect to a series of different fields of the demographics information. In this regard, the different values of the demographics sheet may be emphasized to facilitate the comparison.

Referring to FIG. 3D, the terminal 100, when an update symbol ‘h’ is selected, may display the keys whose value has been changed and the values thereof in a popup window P (i.e., the comparison table).

As shown, the comparison table P has two columns, each representing information (i.e., values of the key) before and after an update event. The comparison table P allows a user to compare the values (information) before and after the update event.

Referring to FIG. 3E, when a field of the demographics sheet is selected, the selected field may be graphically highlighted (h′), while the update node in the event tree corresponding to the selected field may also be graphically highlighted (h). If the selected field value has never been modified, none of the update symbols is highlighted. Because of the highlights h′ and h, the update of the patient information (or values of the key of the patient information) can be intuitively recognized in the event tree.

Referring to FIG. 3F, when an update node in the event tree is selected, a popup window P (i.e., comparison table) may be displayed to show the update/change of the patient information (or values of the key of the patient information).

FIG. 3G illustrates different states of the demographics view. The demographics view may have three possible states: nothing-selected state, field-selected state and node-selected state. The initial state is the nothing-selected state.

In a counterclockwise direction from the top, in the initial state (i.e., nothing-selected state), none of the values/keys of the electronic patient information is selected. In nothing-selected state, the demographics sheet displays the current demographics information of the patient, but no field is selected. Accordingly, although the event tree is displayed, no node is selected or highlighted.

When one of the field of the electronic patient information is selected in the nothing-selected state, the update node corresponding to the selected field may be selected and graphically highlighted, as shown in the field-selected state. That is, in the field-selected state, the demographics sheet displays the current demographics information of the patient, with the selected field shown as selected. Further, the event tree highlights the update nodes where the selected field value was updated.

Finally, when an update node is selected in the field-selected state, a comparison table is displayed as a popup window as shown in the node-selected state. Specifically, in the node-selected state, the demographics sheet displays the current demographics information of the patient while the event tree highlights the selected node. The comparison table also displays the values (before and after the update) of the field.

FIG. 3H illustrates a comparison view in accordance with an exemplary embodiment. The comparison view allows a user to compare demographics information of two different patients. In other words, the comparison view displays the demographics information of two patients, and allows the user to choose to highlight demographics information having different values. As illustrated, two patients' demographics information are displayed side-by-side, on the left and right side of the screen of the terminal 100. Each patient's demographics information is displayed in the event tree as well as the demographics sheet.

The demographics sheet of each patient may emphasize the fields where the values are different between the two patients. Using the comparison view as explained above, the user may be able to determine whether the two patients are actually the same person, based on his/her own determination.

Such manual determination may be made when the matching ratio between the electronic patient information of two patients is greater than or equal to the third preset threshold value (e.g., 80%) and less than the first preset threshold value (e.g., 90%).

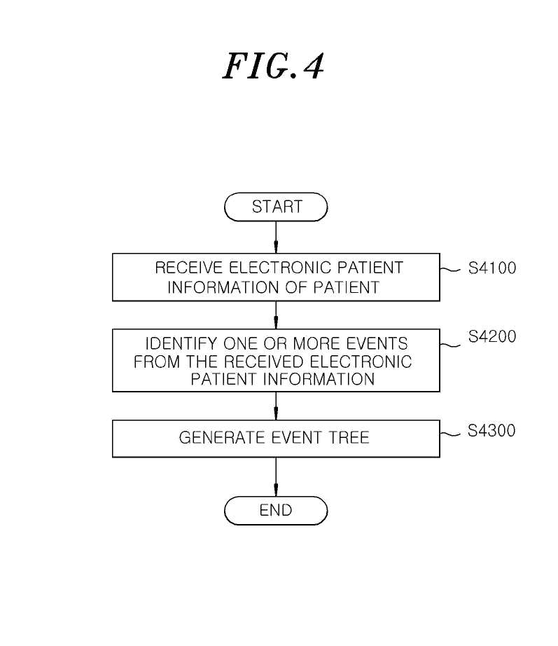

FIG. 4 is a flow-chart illustrating the method of providing electronic patient information in accordance with an exemplary embodiment.

Referring to FIG. 4, the electronic patient information server receives the electronic patient information of a patient from the at least one terminal (S4100).

Next, the electronic patient information server 300 identifies one or more events from the received electronic patient information (S4200).

The electronic patient information server then generates an event tree of a patient based on the identified events (S4300).

Description of the disclosure as mentioned above is intended for illustrative purposes only. It will be understood by those having ordinary skill in the art that embodiments described herein can be easily modified into other specific forms without changing the technical idea or the essential characteristics of the systems and methods described herein. Accordingly, it should be understood that the embodiments described above are exemplary in all respects and not limited thereto. For example, components described separately from one another may be implemented as an integrated type.

The scope of the present invention is represented by the claims described below and it should be construed that all modifications or changes derived from the meaning and scope of the claims and their equivalent concepts are intended to be fallen within the scope of the present invention.

1. A method for providing electronic patient information, implemented at an electronic patient information server, comprising:
receiving electronic patient information of a patient from at least one terminal;
identifying one or more events from the received electronic patient information; and
generating an event tree of the patient based on the identified events,
wherein the event tree graphically represents the electronic patient information of the patient.

2. The method of claim 1, further comprising:
matching the electronic patient information of the patient represented in the event tree of the patient with electronic patient information of another patient represented in an event tree of said another patient; and
merging the event tree of the patient and that of said another patient if a matching ratio exceeds a first threshold value, and transmitting the event tree of the patient and that of said another patient to at least one terminal if the matching ratio does not exceed the first threshold value but exceeds a third threshold value which is lower than the first threshold value.

3. The method of claim 2, wherein, if the matching ratio exceeds the first threshold value but does not exceed a second threshold value which is greater than the first threshold value, the event tree of the patient and that of said another patient are merged at a node having a first symbol, the first symbol indicating that the electronic patient information of the patient and that of said another patient are matched in part.

4. The method of claim 2, wherein, if the matching ratio exceeds a second threshold value which is greater than the first threshold value, the event tree of the patient and that of said another patient are merged at a node having a second symbol, the second symbol indicating that the electronic patient information of the patient and that of said another patient are identical.

5. The method of claim 2, wherein, in the event of merging, one of the event trees of the patient and said another patient is graphically deactivated.

6. The method of claim 1, further comprising: transmitting the generated event tree to a terminal when the electronic patient information server receives a request regarding the patient from the terminal.

7. The method of claim 1,
wherein the electronic patient information includes one or more keys and at least one value corresponding to each of said one or more keys, each key representing an item of the electronic patient information, and
wherein said one or more events include a generation event which indicates a generation of a new key in the electronic patient information of the patient and an update event which indicates a change of a value in the electronic patient information of the patient.

8. The method of claim 7 wherein the generation event is represented as a generation symbol and the update event is represented as an update symbol in the event tree.

9. The method of claim 8, wherein the generation symbol is a circle and the update symbol is a quadrangle.

10. The method of claim 1, wherein the event tree has a tree structure including one or more nodes, each of said identified events corresponds one of the nodes, the nodes in the event tree are arranged in the events' chronological order.

11. The method of claim 10, wherein two neighboring nodes are spaced apart from each other on the event tree at a predetermined distance.

12. An electronic patient information server for providing electronic patient information to at least one terminal, the electronic patient information server configured to perform steps of:
receiving electronic patient information of a patient from the at least one terminal;
identifying one or more events from the received electronic patient information; and
generating an event tree of the patient based on the identified events,
wherein the event tree graphically represents the electronic patient information of the patient.

13. The electronic patient information server of claim 12,
wherein the electronic patient information server is configured to further perform steps of:
matching the electronic patient information of the patient represented in the event tree of the patient with electronic patient information of another patient represented in an event tree of said another patient; and
merging the event tree of the patient and that of said another patient if a matching ratio exceeds a first threshold value, and transmitting the event tree of the patient and that of said another patient to the at least one terminal if the matching ratio does not exceed the first threshold value but exceeds a third threshold value which is lower than the first threshold value.

14. The electronic patient information server of claim 13,
wherein, if the matching ratio exceeds the first threshold value but does not exceed a second threshold value which is greater than the first threshold value, the event tree of the patient and that of said another patient are merged at a node having a first symbol, the first symbol indicating that the electronic patient information of the patient and that of said another patient are matched in part.

15. The electronic patient information server of claim 13,
wherein, if the matching ratio exceeds a second threshold value which is greater than the first threshold value, the event tree of the patient and that of said another patient are merged at a node having a second symbol, the second symbol indicating that the electronic patient information of the patient and that of said another patient are identical.

16. The electronic patient information server of claim 13, wherein, in the event of merging, one of the event trees of the patient and said another patient is graphically deactivated.

17. The electronic patient information server of claim 12, wherein the electronic patient information server further performs a step of transmitting the generated event tree to a terminal when the electronic patient information server receives a request regarding the patient from the terminal.

18. The electronic patient information server of claim 12, wherein the event tree has a tree structure including one or more nodes, each of said identified events corresponds one of the nodes, the nodes in the event tree are arranged in the events' chronological order, and wherein two neighboring nodes are spaced apart from each other on the event tree at a predetermined distance.

19. A computer-readable storage medium storing a computer program which, when executed by a processor, causes the processor to perform the method according to claim 1.

20. A computer-readable storage medium storing a computer program which, when executed by a processor, causes the processor to perform the method according to claim 2.
